(19) United States
(12) Patent Application Publication
(10) Pub. No.: US 2015/0264336 A1
(43) Pub. Date: Sep. 17, 2015

(54) System And Method For Composite Three Dimensional Photography And Videography

(71) Applicant: Jacob D. Catt, Washington, DC (US)

(72) Inventor: Jacob D. Catt, Washington, DC (US)

(21) Appl. No.: 14/660,211

(22) Filed: Mar. 17, 2015

Related U.S. Application Data
(60) Provisional application No. 61/953,974, filed on Mar. 17, 2014.
(60) Provisional application No. 61/975,039, filed on Apr. 4, 2014.

(51) Int. Cl. H04N 13/02

(52) U.S. Cl. CPC H04N 13/0239; H04N 13/0296

(57) ABSTRACT

In one embodiment, a method of creating and viewing a three dimensional video feed, comprises synchronizing a left imaging device and a right imaging device, wherein the imaging devices are positioned next to one another. An image processing engine then captures an image stream on each imaging device, and generates a coded digital image feed. The coded digital image feeds are transmitted to a viewing device, where they may be combined into a 3D image stream. The 3D image stream may then be viewed in a 3D viewing device. In some embodiments, the 3D image stream may be subsequently stored on the imaging device, 3D viewing device, or uploaded to external services, such as social media services.

### CROSS-REFERENCE TO RELATED APPLICATIONS

The present application claims priority to U.S. Provisional Patent Application Serial No. 61/953,974 for “Dual Camera Three Dimensional Shooting Case”, filed Mar. 17, 2014; and U.S. Provisional Patent Application Ser. No. 61/975,039 for “Method for Composite Three Dimensional Camera Feed”, filed Apr. 4, 2014; the disclosures of which are incorporated herein by reference.

### FIELD OF THE DISCLOSURE

The present disclosure generally relates to the field of photography and videography. In particular, the present disclosure relates to systems and methods for performing the capture of three dimensional (3D) photographs and videos.

### BACKGROUND

Conventional photography and videography is performed using devices such as cameras, iPhones, other types of smart phones, computer tablets, and the like. Such devices typically capture two dimensional images and videos. Capturing three dimensional images and videos requires either specialized devices or multiple devices. However, specialized devices are expensive and inconvenient. When using multiple devices, it is difficult to combine the image feeds from the devices for a useable three dimensional image or video. Further, when using multiple devices, it is difficult to position these devices to obtain the proper alignment for a useable three dimensional image or video.

In recent years, amateur photography and videography have become more common. The level of sophistication necessary for three dimensional photography and videography remains high. A convenient method for three dimensional photography/videography has not been implemented for amateurs. Specialized equipment and positioning multiple devices is inconvenient and difficult for amateur photographers and videographers.

Currently, some of these issues are addressed in a variety of ways, with varying degrees of success. In some cases, the solutions to these issues are expensive, thereby raising the price of the components and preventing accessibility to 3D photography and videography by the average consumer. Thus, there is a need for a device and method of three dimensional photography and videography that can address these issues in a cost-effective manner.

### SUMMARY

The problems of the prior art are addressed by a novel system and method for three dimensional photography and videography. In one embodiment, a system according to the disclosure comprises a first imaging device and a second imaging device which provide left and right views of an image. The images are conveyed to a viewing device, which combines the images into a composite 3D image. The 3D image is temporarily stored in memory, and subsequently played back by a 3D viewing screen. Further, the resulting image may be stored locally, or transmitted to external services, such as social media services. Accordingly, embodiments of the disclosure seek to provide a method to combine digital image feeds from photography and/or videography devices into a three dimensional image or video that reduces the need for sophisticated knowledge and equipment to produce three dimensional photographs and videos.

In another embodiment of the disclosure, the problems of the prior art are addressed by a novel a case for amateur photography and videography devices that reduces the need for sophisticated knowledge to take capture three dimensional photographs or video. A case according to the disclosure may be configured such that an end user may place two devices within the case. The case may be designed to fit each device in a specific position. The pre-set position of each device aligns lenses of the imaging devices so that the resulting photographs or videos can be combined to create a three dimensional photograph or video. The photograph or video produced by both devices may be combined into a three dimensional image or video on one device by way of Bluetooth, a wireless connection, or a wired connection, such as a cable.

### BRIEF DESCRIPTION OF THE DRAWINGS

FIGS. 1 through 5, wherein like parts are designated by like reference numerals throughout, illustrate an example embodiment of a system and method for the implementation of a three dimensional photography and videography system. Although the present disclosure describes the system and method with reference to the example embodiments described in the figures, it should be understood that many alternative forms can embody the present disclosure. One of ordinary skill in the art will additionally appreciate different ways to alter the parameters of the embodiments disclosed in a manner still in keeping with the spirit and scope of the present disclosure.

FIG. 1 is a schematic diagram illustrating a 3D capture and viewing system according to an embodiment of the disclosure;

FIG. 2A is a perspective view of the case of FIG. 1 separated into its component parts of a lens housing and a base, and FIGS. 2B-D are front, rear, and side vides of the case with the lens housing attached to the base;

FIG. 3 is a schematic diagram illustrating components of the imaging devices and viewing device of FIG. 1 in further detail;

FIG. 4 is a flow diagram of a method of combining two digital image feeds from two imaging devices and projecting the combined feed to a 3D viewing screen; and

FIG. 5 is a flow diagram of a method of combining two digital image feeds, synchronizing the feeds, and projecting the combined and synchronized feed to a 3D viewing screen.

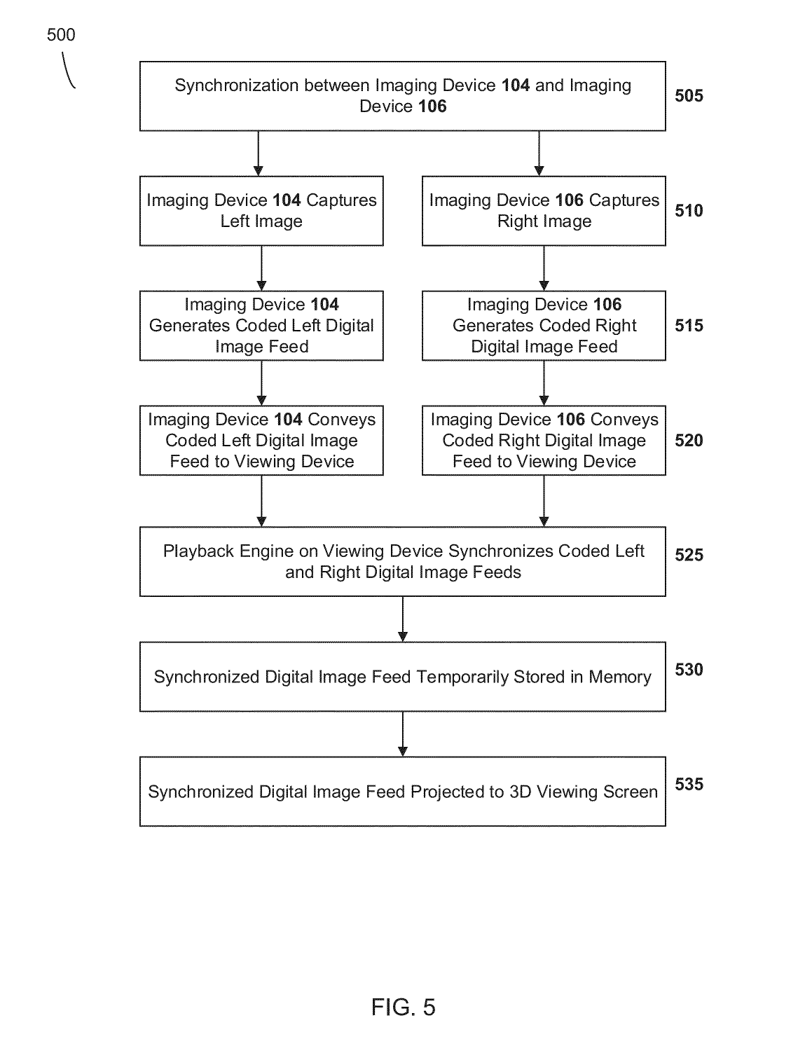

### DETAILED DESCRIPTION

The present disclosure features a novel approach for creating and playing back three dimensional images and videos. The detailed description set forth below in connection with the appended drawings is intended as a description of embodiments and does not represent the only forms which may be constructed and/or utilized. However, it is to be understood that the same or equivalent functions and sequences may be accomplished by different embodiments that are also intended to be encompassed within the spirit and scope of the disclosure.

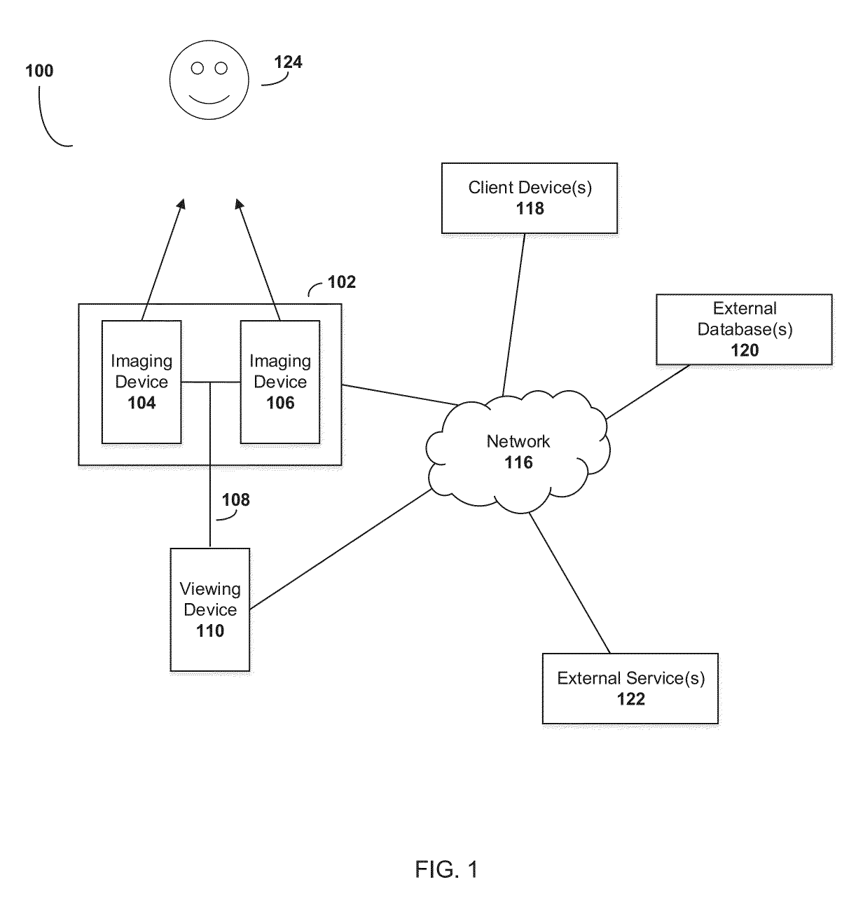

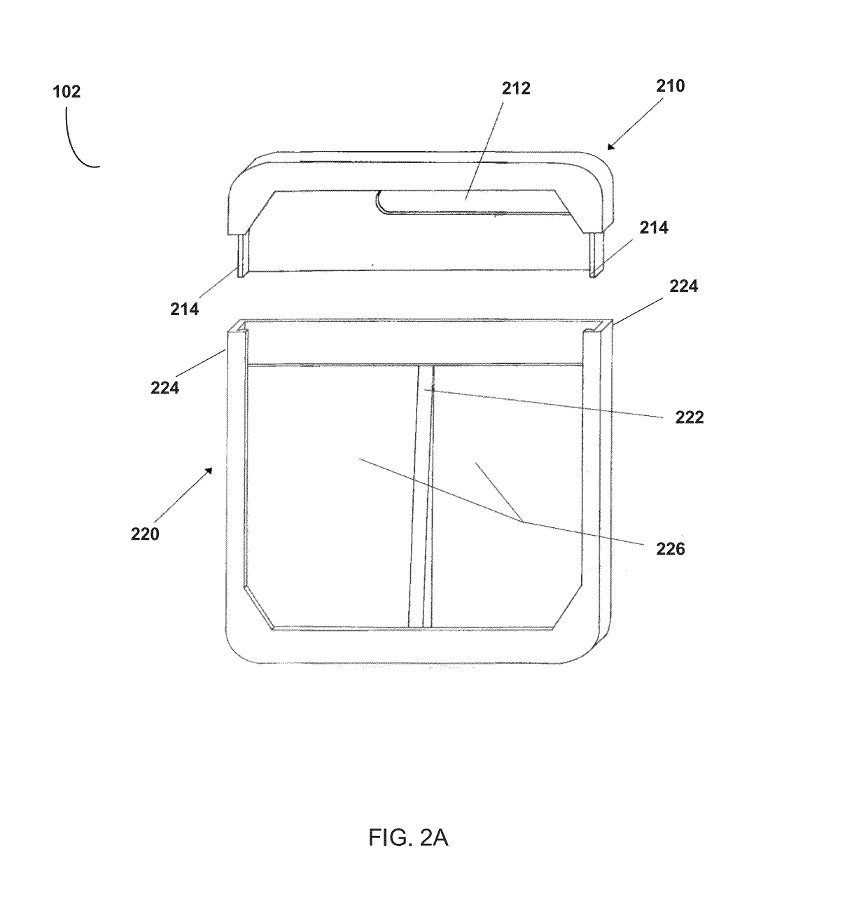

FIG. 1 is a schematic diagram illustrating an example embodiment of a 3D capture and viewing system 100 suitable for practicing exemplary embodiments of the present disclosure. The 3D capture and viewing system 100 may be used for capturing 3D images and video, displaying 3D images and video, and distributing 3D images and video to various clients, servers, and viewing devices.

As shown in this embodiment, the 3D capture and viewing system 100 comprises a first imaging device 104 and a second imaging device 106. Typically, the imaging devices 104, 106 are positioned such that the first imaging device 104 is positioned to the left of the second imaging device 106, such that the captured images may be stereoscopic. The imaging devices 104, 106 may be positioned within a case 102 specifically designed for three dimensional photograph and videography. The imaging devices 104, 106 may communicate with one another and a viewing device 110 via a local connection 108. Each of the imaging devices 104, 106 and viewing device 110 may further communicate with client devices 118, external databases 120, and external services 122 via a network 116. Each of the imaging devices 104, 106 may capture an image, such as of a model 124. The imaging devices 104, 106 may then transmit the captured images to the viewing device 110 for viewing and subsequent processing.

The imaging devices 104, 106 are configured to synchronize with one another such that they may capture two images concurrently, e.g., a left image and a right image of a model 124, creating a stereoscopic view. The imaging devices 104, 106 may comprise any electronic device capable of capturing a digital image. The imaging devices 104, 106 may be configured to interact with the viewing device 110, client devices 118, external databases 120, and/or external services 122 to deliver an image or set of images comprising 3D images and video. Depending on particular implementation requirements of the present disclosure, the imaging devices 104, 106 may be any kind of electronic device with imaging capabilities, such as a camera, a digital camera, a cell phone, a mobile device, a tablet device, a personal digital assistant, or any other form of computing device or imaging device. For example, the imaging devices 104, 106 may be a pair of iPhones. In certain embodiments, the imaging devices 104, 106 may comprise the same kind of imaging device. However, in other embodiments, the imaging devices 104, 106 may comprise different kinds of imaging devices, but executing the same software. For example, the imaging devices 104, 106 may comprise an iPhone and an Android device, each executing an application comprising components of the 3D capture and viewing system 100.

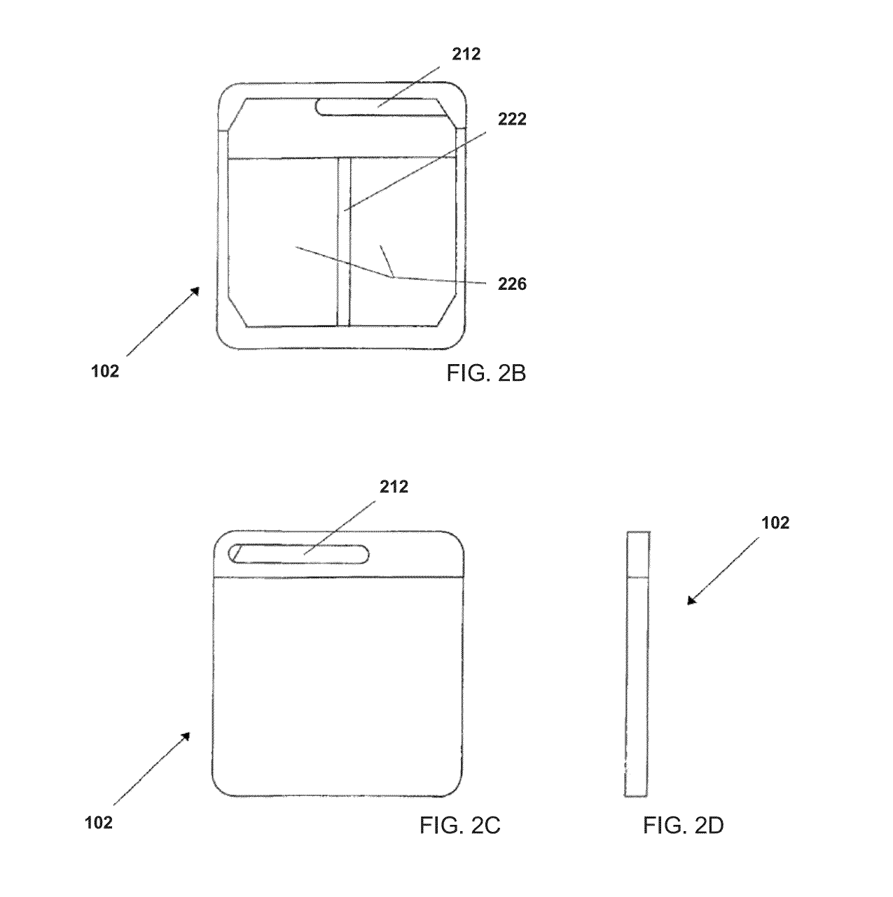

The case 102 may comprise any apparatus or method of correctly positioning the imaging devices 104, 106 to allow for three dimensional photography or videography. For example, the case 102 may comprise a molded plastic shell configured to receive the imaging devices 104, 106 such that cameras on the imaging devices 104, 106 are oriented towards the model 124. Further, the case 102 may be configured such that cameras of the imaging devices 104, 106 are separated by a distance that falls within the average human interpupillary distance (IPD), from 50-75 mm. For example, the lens centers may be separated by 63 mm, thus better simulating a view from human eyes. The case 102 will be described in further detail below with respect to FIGS. 2A-D. However, in certain embodiments, a 3D capture and viewing system 100 according to the disclosure may lack a case 102. For example, an end user may simply hold two imaging devices 104, 106 together to approximate a stereoscopic view.

The local connection 108 may comprise any form of connection for enabling communication between the imaging devices 104, 106 and viewing device 110. For example, the local connection 108 may be a wired connection, such as a serial or USB connection. Alternately, the local connection may comprise wireless connections, such as wireless LAN, Bluetooth, near field communication (NFC), and the like. In certain embodiments, the imaging devices 104, 106 may communicate with the viewing device 110 via a second local connection. In still further embodiments, the imaging devices 104, 106 may communicate with the viewing device over the network 116.

The viewing device 110 may comprise any form of computing and/or viewing device. In this embodiment, the viewing device 110 is configured to receive images and/or video from the imaging devices 104, 106 over the local connection 108. The images may be separated by left and right views, which the viewing device 110 is configured to combine or associate with one another into a single 3D view. The viewing device 110 may be configured to interact with any of the client devices 118, external databases 120, and external services 122 to create and deliver a 3D image or video. Depending on particular implementation requirements of the present disclosure, the viewing device 110 may be any type of computing system, such as a workstation, server, desktop computer, laptop, handheld computer, cell phone, mobile device, tablet device, personal digital assistant, networked game or media console, or any other computing device or system.

The imaging devices 104, 106 and viewing device 110 may have sufficient processing power and memory capacity to perform all or part of the operations described herein, or alternately may only serve as a proxy, with some or all functions performed externally by a server or other computing device. In some embodiments, all or parts of the imaging devices 104, 106 and viewing device 110 may be wearable, e.g., as a component of a wrist watch, smart glasses, or other article of clothing. The imaging devices 104, 106 and viewing device 110 may be embodied as a stand-alone system, or as a component of a larger electronic system within any kind of environment. In certain embodiments, the 3D capture and viewing system 100 may comprise multiples of imaging devices 104, 106 and viewing devices 110.

The imaging devices 104, 106 and viewing device 110 can comprise a processor, memory, and storage. The processor may be any hardware or software-based processor, and may execute instructions to cause any functionality, such as applications, clients, and other agents, to be performed. Instructions, applications, data, and programs may be located in memory or storage. Further, an operating system may be resident in storage, which when loaded into memory and executed by a processor, manages most device hardware resources and provides common services for computing programs and applications to function.

Further, the imaging devices 104, 106 and viewing device 110 may comprise various interfaces for communicating with other computing devices and for interacting with end users. For example, the devices may access the network 116 via one or more network input/output (I/O) interfaces, which can comprise either hardware or software interfaces between equipment or protocol layers within a network. For example, the network I/O interfaces may comprise Ethernet interfaces, frame relay interfaces, cable interfaces, DSL interfaces, token ring interfaces, wireless interfaces, cellular interfaces, and the like. End users may interact with the imaging devices 104, 106 and viewing device 110 via one or more user I/O interfaces. User I/O interfaces may comprise any input or output devices that allow an end user to interact with the imaging devices 104, 106 and viewing device 110. For example, input devices may comprise various buttons, a touch screen, microphone, keyboard, touchpad, joystick, and/or any combination thereof. Output devices can comprise a screen, speaker, and/or any combination thereof. Thus, the end user may interact with the imaging devices 104, 106 and viewing device 110 by pressing buttons, tapping a screen, speaking, gesturing, or using a combination of multiple input modes. In turn, the imaging devices 104, 106 and viewing device 110 or other component may respond with any combination of visual, aural, or haptic output. The imaging devices 104, 106 and viewing device 110 may manage the user I/O interfaces and provide a user interface to the end user by executing a stand-alone application residing in storage. Alternately, a user interface may be provided by an operating system executing on the camera imaging devices 104, 106 and viewing device 110.

Each of the components of the 3D capture and viewing system 100 may communicate with other devices and computers via the network 116. The network 116 can be any network, such as the Internet, a wired network, a cellular network, a wireless network, and the like. The network 116 may also comprise local connections, such as serial, USB, local area network (LAN), wireless LAN, Bluetooth, or other forms of local connections. Accordingly, various embodiments of the disclosure may utilize various networks to capture, synchronize, and display 3D images and video.

The client devices 118 may be configured to receive information from the imaging devices 104, 106 and viewing device 110, such as 3D images and/or video created by the 3D capture and viewing system 100. For example, the client devices 118 may access the imaging devices 104, 106 or viewing device 110 via an API or website over the network 116. Client devices 118 may comprise any client computing device, such as personal computers, laptop computers, server computers, slate devices, mobile phones, smart phones, tablet devices, and the like.

The external databases 120 may comprise various storage systems for remotely storing and accessing data by the imaging devices 104, 106, viewing device 110, or other components of the 3D capture and viewing system 100. The external services 122 may comprise various server computing devices, cloud computing systems, or other sites, systems, or devices hosting external services to access remote data or remotely executing applications. Each of these components may be accessed over the network 116. For example, the external services 122 may provide an API accessible over the network 116 which is configured to respond to client requests for various 3D content, and appropriately format and deliver the result. External services 122 may also comprise social networking or other media providers, such as Facebook and YouTube.

FIGS. 2A-D illustrate an exemplary embodiment of the case 102 of FIG. 1. FIG. 2A illustrates the case 102 in a dissembled state, and FIGS. 2B-D illustrate the case in an assembled state. The case 102 is configured such that an end user may play two imaging devices (e.g., the imaging devices 104, 106) within the case. The case may be designed to fit each imaging device in a specific position. The pre-set position of each device aligns lenses of the imaging devices so that the resulting photographs and/or videos may be combined to create a three dimensional photograph or video.

As shown in this embodiment, the case 102 can comprise a lens housing 210 and a base 220. The lens housing 210 may be separable from the base 220 and configured to releasably attach to and detach from the base 220, thus allowing for placement of a device within. The lens housing 210 further comprises a lens opening 212 and attachment features 214. The base 220 comprises a separating panel 222, a receiving section 224, and two device holding areas 226.

The attachment features 214 can comprise a tabbed portion extending down from the lens housing 210 and are configured to be received by the receiving section 224. The receiving section 224 comprises a grooved section corresponding to the size of the attachment features 214. Accordingly, as shown in FIG. 2A, the lens housing 210 and base 220 may be initially separated. As shown in FIGS. 2B-D, placing or sliding the attachment features 214 within the receiving section 224 completes assembly of the case 102. The process may be carried out in reverse to separate the case 102.

When the lens housing 210 and base 220 are separated, two devices may be placed within the device holding areas 226. The device holding areas 226 may be sufficiently wide and long to insert desired photography or videography equipment, such as the imaging devices 104, 106 of FIG. 1. For example, the device holding areas in a case 102 configured to fit an iPhone would be approximately 2½ inches wide, 3½ inches long, and ½ inch deep.

The inserted equipment may be separated by a separating panel 222. However, in certain embodiments, a case 102 according to the disclosure may lack the separating panel 222. The lens opening 212 is configured such that when equipment is placed within the case 102 and the lens housing 210 is secured to the base 220 (as shown in the embodiment of FIGS. 2B-D), the lens opening 212 is positioned over a camera of the inserted equipment. While in this embodiment, the lens opening 212 comprises a single opening or aperture within the lens housing 210, the lens opening may comprise multiple openings or apertures within the lens housing 210.

The case 102 may be made from a variety of materials. For example, the case 102 may comprise molded plastic, or any other sufficiently rigid and strong material such as wood, metal, and the like. The case 102 may also comprise combinations of these materials. For example, the case 102 may comprise plastic with a metal lining. In certain embodiments, the lens opening 204 may also comprise clear plastic or glass.

As shown in the embodiment of FIGS. 2B-D, the assembled case 102 completely encases the two photography or videography devices (such as the imaging devices 104, 106 of FIG. 1), with a lens or camera of each respective device capable of capturing images and video through the lens opening 212. However, in certain embodiments, a case according to the disclosure may only partially encase the enclosed equipment.

Advantages of the case 102 according to this embodiment of the disclosure include, without limitation, that it is portable and exceedingly easy for the user to insert the photography and videography devices with the lens of each device capable of capturing images through the lens opening 212. The case 102 may be relatively small and lightweight, and may easily be assembled in any setting for fast and simple three dimensional photography or videography.

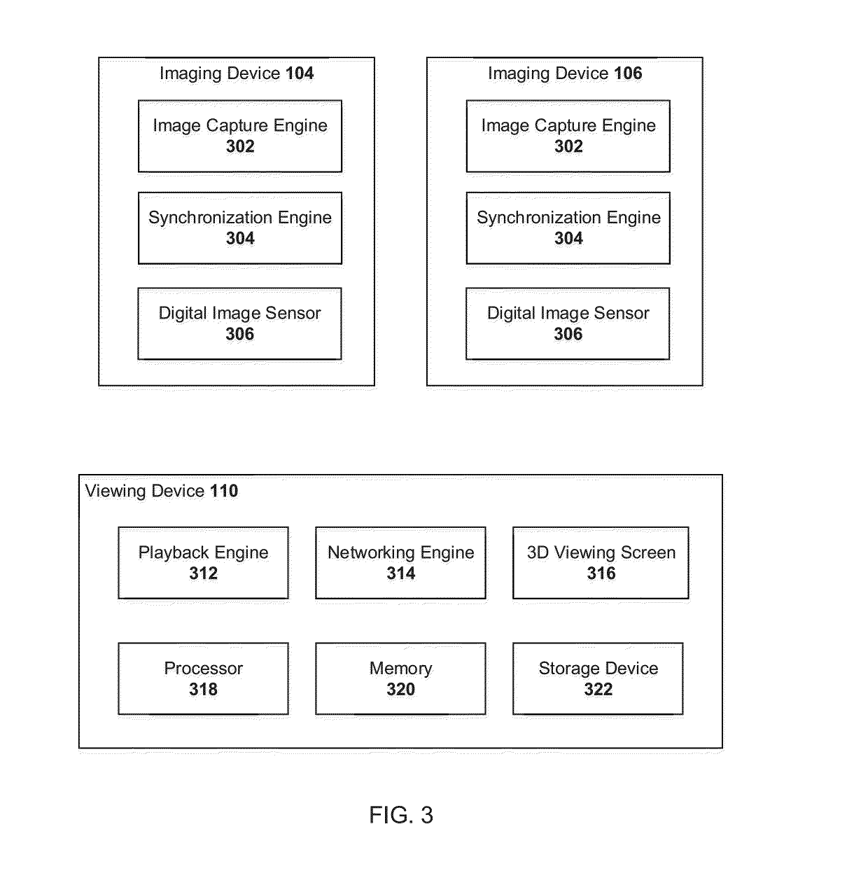

FIG. 3 illustrates various components of the imaging devices 104, 106 and viewing device 110 of FIG. 1. As shown in this embodiment, each imaging device 104, 106 may comprise an image capture engine 302, a synchronization engine 304, and a digital image sensor 306. The imaging devices may further comprise a processor, memory, and storage device (not shown). Each of the engines 302, 304 can comprise code or software based logic that when loaded into memory may be executed by a processor. Each of the engines 302, 304 may further receive data, such as image data, from the digital image sensor 306. The image capture engine 302 may be configured to receive image data from the digital image sensor 306 and create a digital image. For example, the image capture engine 302 can comprise software routines executing on a processor to process images captured by the digital image sensor 306. The image capture engine 302 may store captured images and video in local or external storage, compress images, convert images between different file formats, adjust lighting, hue, or saturation, crop, zoom, or perform additional corrections and alterations. Further, the image capture engine 302 and synchronization engine 304 may communicate with one another or other software routines during execution.

The synchronization engine 304 is configured to initiate communication with another imaging device that is appropriately configured. For example, the synchronization engine 304 may initiate communication between the imaging devices 104, 106. In one embodiment, after placing the imaging devices 104, 106 in sufficient proximity to one another (e.g., by using the case 102 of FIGS. 2A-D), an end user may initiate synchronization by pressing an appropriate button or selecting an option via a user interface available on one of the imaging devices 104, 106. The respective synchronization engines 304 may then communicate with one another via Bluetooth, NFC, and the like. The synchronization engines 304 may determine which imaging device represents the left or right view. The synchronization engines 304 may determine which device is the “master” device. Finally, the synchronization engines 304 may associate images captured at the same moment by each imaging device 106 with one another. The synchronization engine 304 may perform this, for example, by synchronizing the time between the devices 104, 106 and subsequently applying a time-stamp to each captured image. The synchronization engine 304 may also perform a de-synchronizing or de-coupling step once 3D image or video capture is complete.

The digital image sensor 306 may comprise any digital image sensor capable of generating a digital image or video. In certain embodiments, sensor resolution may range depending on the application. For example, the sensor may be able to capture several megapixels (1,000,000 pixels) of information for an image. For video, the sensor may capture sufficient pixels to create standard definition (480i), high definition (1080p), or even ultra-high definition (4K) image streams. In this embodiment, each imaging device 104, 106 has its own digital image sensor 306. However, in certain embodiments, a single imaging device 104, 106 may comprise two digital image sensors 306.

Once synchronized, an end user may initiate image or video capture on the imaging devices 104, 106 by pressing an appropriate button or selecting an option via a user interface available on one of the imaging devices 104, 106. Once initiated, image data and feeds may be transmitted to the viewing device 110 (e.g., over the local connection 108 of FIG. 1) for subsequent viewing and/or additional processing.

As shown in this embodiment, the viewing device 110 comprises a playback engine 312, a networking engine 314, and a 3D viewing screen 316. Further, the viewing device 110 may also comprise a processor 318, a memory 320, and a storage device 322. Similar to the engines 302, 304 of the imaging devices 104, 106, each of the engines 312, 314 comprise software and/or code configured to instruct the processor 318 to take various actions related to 3D capture and playback. In this embodiment, the playback engine 312 is configured to receive digital images, digital image feeds, video, and the like from the imaging devices 104, 106. The playback engine 312 may then combine the feeds into a 3D image feed, and then project the 3D image feed to the 3D viewing screen 316.

Further, the viewing device 110 may utilize the networking engine 314 to submit the 3D image feed to other external databases or services, such as by uploading the 3D image feed to a social networking service such as Facebook, Twitter, and the like. In certain embodiments, the end user may select this option via an appropriate selection in a user interface available on the imaging devices 104, 106 and/or viewing device 110. In certain embodiments, this feature may be automatic, such that all 3D image feeds are automatically uploaded to an external service. This feature may be beneficial as an automatic backup feature, for example.

The image capture engine 302 and playback engine 312 may store or access 3D images and video in a variety of formats. For example, suitable file formats for stereo images include Multi-Picture Object (MPO), which consists of multiple JPEG images; PNG Stereo Format (PNS), which consists of a side-by-side image using the Portable Network Graphic (PNG) standard; and JPEG Stereo Format (JPS) which consists of a side-by-side format based on JPEG. Alternately, left and right images may be saved separately in a single-image file format and named accordingly so that the two files are linked. For video, suitable 3D file formats include MTS, MPEG4-MVC, AVCHD, and the like.

Captured images or video may be displayed immediately on the 3D viewing screen 316. The 3D viewing screen 316 can comprise any form of 3D viewer or apparatus, such as a virtual reality headset with two OLED screens, wherein each OLED screen is viewable by only one eye. The 3D viewing screen may also comprise a 3D television or other form of 3D display, such as a handheld unit. In certain embodiments, the imaging devices 104, 106 may further comprise 3D viewing screens such that captured images and video may be displayed on the imaging device itself. As explained above, captured images or video may also be transmitted to and displayed by an external 3D viewer or viewing apparatus such as a client device, e.g., the client devices 118 of FIG. 1.

In certain embodiments, the 3D viewing screen 316 may comprise an autostereoscopic. Autostereoscopy refers to any method of displaying stereoscopic images without the use of special equipment by the viewer. Autostereoscopic screens may utilize a parallax barrier to present a 3D view to an end user. In this case, the parallax barrier is placed in front of an LCD screen so that each eye only sees a separate set of pixels corresponding to left and right images. Thus, a stereo image captured by the two cameras can be presented in a simulated 3D view on the autostereoscopic screen. In still further embodiments, other kinds of autostereoscopic displays can be used, such as lenticular lens, volumetric display, holographic, light field displays, and the like.

In still further embodiments, the 3D viewing screen 316 may comprise a display that requires specialized glasses and/or hardware. For example, the 3D viewing screen 316 may use an active shutter system, wherein a single display presents an image for the left eye while blocking out the right eye view, and then presents the right eye image while blocking the left eye view. The process is repeated at a sufficient rate so that the interruptions do not interfere with the perceived fusion of the two images into a single 3D image. The 3D viewing screen 316 can also comprise passive systems, such as polarization systems. In this case, two images are projected onto a screen through a polarizing filter. The viewer then wears low-cost eyeglasses which also contain a pair of opposite polarizing filters, thus presenting a different image to each eye. Various other 3D viewers and 3D viewing screens are known in the art and may be used to view captured stereoscopic images and video from the imaging devices 104, 106.

In operation, an end user holds the case 102 with the front facing the desired scene to be captured (e.g., the model 124 of FIG. 1). The end user may then initiate synchronization and recording processes via the user I/O interfaces available on either of the imaging devices 104, 106. In certain embodiments, the end user may begin 3D capture by pressing a dedicated button available on either one of the imaging devices 104, 106 or case 102. Captured images and/or video may be stored locally on the imaging devices 104, 106 and played back locally, or alternately stored externally and played on a separate device (e.g., stored on external databases 120 or external services 122 and played back on client devices 118). For example, in certain embodiments, images and video may be captured from the imaging devices 104, 106, combined into a 3D image or video, and submitted to a social networking service, where it may subsequently be viewed on various client devices, such as a mobile phone equipped with an autostereoscopic viewing screen.

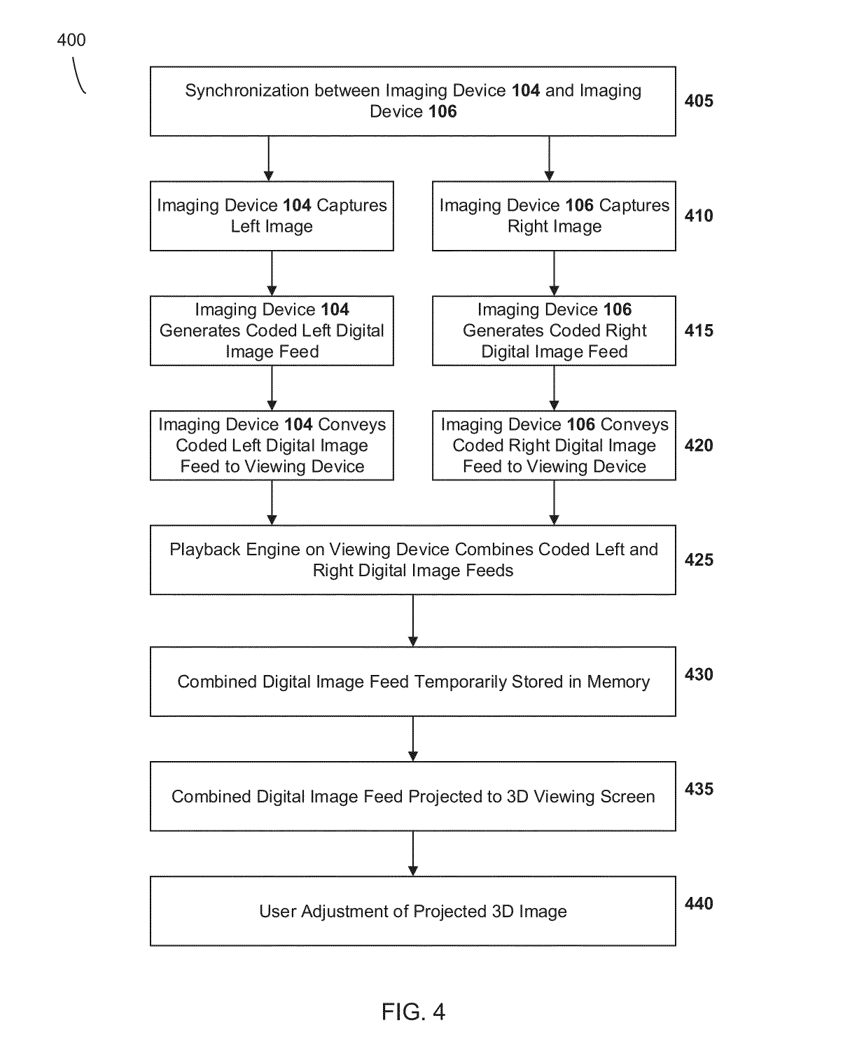

FIG. 4 illustrates an exemplary embodiment of a method 400 of capturing and viewing 3D images and video according to the disclosure. The method 400 may be practiced in the context of a 3D capture and viewing system 100, and may begin by synchronizing, such as via the synchronization engines 304 of FIG. 3, the first imaging device 104 and second imaging device 106 (step 405). Next, imaging devices 104, 106 concurrently capture left and right digital image feeds, respectively (step 410). The left and right digital image feeds are then converted into a coded digital image feed by the image capture engine 302 (step 415), which are conveyed to the viewing device 110 (step 420). In this embodiment of the disclosure, the playback engine 312 on the viewing device 110 then simply combines the coded digital image feeds into a single 3D image feed (step 425), and temporarily stores the feed in memory (step 430). The combined digital image feed is then projected to the 3D viewing screen 216 (step 435). Finally, the end user may adjust the projected 3D image as needed to maximize the 3D effect (step 440).

Further, the end user may decide to store or transmit the resulting 3D image and 3D image feed. For example, the end user may decide to store the 3D image feed on an external storage device, such as via the external services 122 of FIG. 1. The end user may decide to submit the resulting 3D video to a social media website or service, such as Facebook, Twitter, any other social media site, and the like. In this situations, the networking engine 314 may communicate over the network 116 to upload the resulting 3D images or feed to various external services 122 (e.g., as shown in the embodiment of FIG. 1). Alternately, the end user may simply decide to store the 3D image feed on the storage device 322 of the viewing device 110, or on the imaging devices 104, 106. For example, end users may store 3D photographs and videos in the end user's smartphone, smart tablet, computer-related devices, or external storage devices. Various embodiments are considered to be within the scope of the disclosure.

FIG. 4 illustrates another exemplary embodiment of a method 500 of capturing and viewing 3D images and video according to the disclosure. Similar to the method 400, the method 500 may be practiced in the context of a 3D capture and viewing system 100, and may begin by synchronizing, such as via the synchronization engines 304 of FIG. 3, the first imaging device 104 and second imaging device 106 (step 505). Next, imaging devices 104, 106 concurrently capture left and right digital image feeds, respectively (step 510). The left and right digital image feeds are then converted into a coded digital image feed by the image capture engine 302 (step 515), which are conveyed to the viewing device 110 (step 520).

In this embodiment of the disclosure, the playback engine 312 on the viewing device 110 then synchronizes the coded digital image feeds, such that individual images within each image feed are temporally aligned with one another (step 525). For example, an additional synchronization may be necessary if images have been received from the imaging devices 104, 106 out of order (e.g., due to network conditions). The playback engine 312 may seek to synchronize the left and right video streams according to timestamps embedded within the frames. In another embodiment, the playback engine 312 may also seek to align the videos using visual cues present in the individual frames. Such alignment may be necessary in situations where either the left or right video stream is out of alignment due to a loss of frames or other interruption.

The synchronized image feed is subsequently stored in memory (step 530) and projected to the 3D viewing screen 216 (step 535).

Either of the methods 400 and 500 may be distributed across multiple devices. For example, portions of the synchronization engine 304 may execute as part of a playback engine 312. Further, the steps of the method 400, 500 may be practiced in any order or by any component of the 3D capture and viewing system 100. In addition, some steps may be omitted, repeated, or performed by multiple devices. Additional steps may also be added.

In still further embodiments, the imaging devices 104, 106 may comprise a single device. In still further embodiments, the imaging devices 104, 106 and viewing device 110 may comprise a single device.

Advantages of embodiments of the present disclosure include, without limitation, that it is exceedingly easy for the user to create 3D photographs or videos without complicated hardware and software, or a detailed knowledge of three dimensional photography or videography techniques. Embodiments of the disclosure may be used in any setting for fast and simple 3D photography or videography.

Having described an embodiment of the technique described herein in detail, various modifications and improvements will readily occur to those skilled in the art. Such modifications and improvements are intended to be within the spirit and scope of the disclosure. Accordingly, the forgoing description is by way of example only, and is not intended as limiting. The techniques are limited only as defined by the following claims and equivalents thereto.

What is claimed is:

1. A method of creating and viewing a three dimensional video feed, comprising:
synchronizing a left imaging device and a right imaging device, said imaging devices positioned next to one another;
capturing, by an image processing engine executing on each imaging device, an image stream;
generating a coded digital image feed on each imaging device from its respective image stream;
transmitting each coded digital image feed to a viewing device;
combining, by a playback engine executing on the viewing device, the coded image streams into a 3D image stream; and
playing back the 3D image stream on a 3D viewing device.

2. The method of claim 1, further comprising submitting the 3D image stream to a social media service.

3. The method of claim 1, further comprising adjusting the projected 3D image by an end user.

4. The method of claim 1, wherein the left imaging device and right image device are placed within a case configured to receive the left imaging device and right imaging device.

5. The method of claim 4, wherein the case is configured such that the left imaging device and right imaging device are spaced apart by between 50 and 75 millimeters.

6. The method of claim 1, wherein synchronizing a left imaging device and a right imaging device comprises synchronizing, by a synchronization agent executing on each of the left imaging device and right imaging device, the left imaging device and right imaging device.

7. The method of claim 1, wherein synchronizing a left imaging device and a right imaging device further comprises communicating with each imaging device via Bluetooth.

8. The method of claim 1, wherein the coded digital image feed comprises a single image.

9. The method of claim 1, wherein the coded digital image feed comprises a plurality of images.

10. The method of claim 1, wherein the coded digital image feed comprises video.
